(19) United States
(12) Patent Application Publication
(10) Pub. No.: US 2025/0013034 A1
(43) Pub. Date: Jan. 9, 2025

(54) VISIBLE LIGHT REGION ACTIVE META DEVICE

(71) Applicant: Electronics and Telecommunications Research Institute, Daejeon (KR)

(72) Inventors: Chi-Sun HWANG, Daejeon (KR); Yong Hae KIM, Daejeon (KR); Joo Yeon KIM, Daejeon (KR); Jaehyun MOON, Daejeon (KR); Jong-Heon YANG, Daejeon (KR); Kyunghee CHOI, Daejeon (KR); Ji Hun CHOI, Daejeon (KR)

(73) Assignee: Electronics and Telecommunications Research Institute, Daejeon (KR)

(21) Appl. No.: 18/596,005

(22) Filed: Mar. 5, 2024

(30) Foreign Application Priority Data
Jul. 5, 2023 (KR) 10-2023-0087165

(51) Int. Cl. G02B 26/08; B82Y 20/00; G02F 1/1343; G02F 1/137

(52) U.S. Cl. CPC G02B 26/0816; B82Y 20/00; G02F 1/13439; G02F 1/137; G02B 2207/101

(57) ABSTRACT

Disclosed is an active meta device. The device includes a metal reflective plate, an insulating layer on the metal reflective plate, a first modulation line block provided on one side of the insulating layer, and a second modulation line block provided on another side of the insulating layer facing the first modulation line block.

### CROSS-REFERENCE TO RELATED APPLICATIONS

This U.S. non-provisional patent application claims priority under 35 U.S.C. § 119 of Korean Patent Application No. 10-2023-0087165, filed on Jul. 5, 2023, the entire contents of which are hereby incorporated by reference.

### BACKGROUND

The present disclosure herein relates to a meta device, and more particularly, to a visible light region active meta device.

In general, few meta devices perform active modulation at visible light region. Meta devices operate in a near infrared region when using ITO electrodes, and operate in a mid-infrared region when using graphene electrodes. Recently, it has been reported that an epsilon near zero (ENZ) frequency at which effective permittivity becomes zero may be adjusted by stacking metals and dielectrics. When the metals and dielectrics are sufficiently thin, effective permittivity may be expressed as below according to a mean field theory. When the permittivity of the metals and ITO follows a Drude model, an effective refractive index may reduce.

### SUMMARY

The present disclosure provides an active meta device having a simple structure and capable of complex modulation in a visible light region.

An embodiment of the inventive concept provides an active meta device including: a metal reflective plate; an insulating layer on the metal reflective plate; a first modulation line block provided on one side of the insulating layer; and a second modulation line block provided on another side of the insulating layer facing the first modulation line block.

In an embodiment, the first modulation line block and the second modulation line block each may include: a transparent conducting layer; and a nano-antenna pattern on the transparent conducting layer.

In an embodiment, a first voltage may be biased between the metal reflective plate and the nano-antenna pattern of the first modulation line block, and a second voltage may be biased between the metal reflective plate and the nano-antenna pattern of the second modulation line block.

In an embodiment, the transparent conducting layer may include indium tin oxide (ITO).

In an embodiment, the first modulation line block and the second modulation line block each may further include an opaque metal layer between the transparent conducting layer and the nano-antenna pattern. In an embodiment, the opaque metal layer may include silver.

In an embodiment, the first modulation line block and the second modulation line block may be alternately arranged with a pitch of at least 700 nm.

In an embodiment, the first modulation line block and the second modulation line block each may have a line width of 44.4 nm to 350 nm.

In an embodiment, the first modulation line block and the second modulation line block may have a separation distance of 50 nm to 350 nm.

In an embodiment, the insulating layer may include alumina.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIGS. 1 and 2 are cross-sectional views illustrating a typical meta device;

FIGS. 3 and 4 are cross-sectional views illustrating an example of an active meta device according to the inventive concept;

FIG. 5 is a cross-sectional view illustrating an example of an active meta device according to the inventive concept;

FIGS. 6A and 6B are cross-sectional views illustrating an example of an active meta device according to the inventive concept; and

FIG. 7 is a graph showing a simulation result pertaining to line widths of a first modulation line block and a second modulation line block relative to a peak wavelength of visible light according to a complex modulation area of an active meta device of the inventive concept.

### DETAILED DESCRIPTION

Embodiments of the inventive concept will now be described in detail with reference to the accompanying drawings. Advantages and features of embodiments of the inventive concept, and methods for achieving the advantages and features will be apparent from the embodiments described in detail below with reference to the accompanying drawings. However, the inventive concept may be embodied in different forms and should not be construed as limited to the embodiments set forth herein. Rather, these embodiments are provided so that this disclosure will be thorough and complete, and will fully convey the scope of the inventive concept to those skilled in the art, and the inventive concept is only defined by the scope of the claims. Like reference numerals refer to like elements throughout.

The terminology used herein is not for delimiting the embodiments of the inventive concept but for describing the embodiments. The terms of a singular form may include plural forms unless otherwise specified. It will be further understood that the terms “includes”, “including”, “comprises”, and/or “comprising”, when used ‘in this description, specify the presence of stated elements, operations, and/or components, but do not preclude the presence or addition of one or more other elements, operations, and/or components. Furthermore, reference numerals, which are presented in the order of description, are provided according to the embodiments and are thus not necessarily limited to the order.

The embodiments of the inventive concept will be described with reference to example cross-sectional views and/or plan views. In the drawings, the dimensions of layers and regions are exaggerated for clarity of illustration. Therefore, the forms of the example drawings may be changed due to a manufacturing technology and/or error tolerance. Therefore, the embodiments of the inventive concept may involve changes of shapes depending on a manufacturing process, without being limited to the illustrated specific forms.

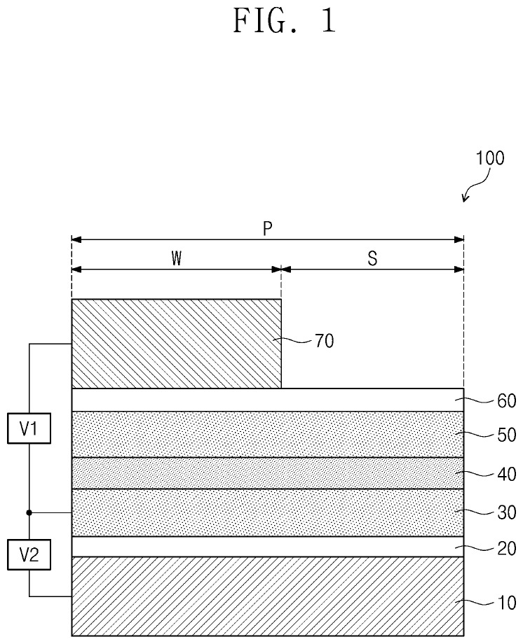

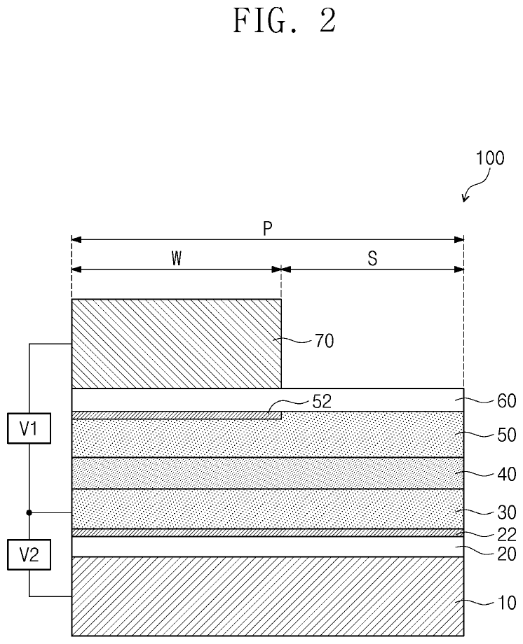

FIGS. 1 and 2 illustrate an example of a typical meta device 100.

Referring to FIG. 1, the typical meta device 100 may be a complex modulation active meta device. The typical meta device 100 may include a metal reflective plate 10, a lower insulating layer 20, a first transparent conducting layer 30, an opaque metal layer 40, a second transparent conducting layer 50, an upper insulating layer 60, and a nano-antenna pattern 70. The lower insulating layer 20, the first transparent conducting layer 30, the opaque metal layer 40, the second transparent conducting layer 50, and the upper insulating layer 60 may be sequentially stacked on the metal reflective plate 10. The nano-antenna patterns 70 may be periodically arranged in one direction on the upper insulating layer 60 with a certain line width W, separation distance S, and pitch P.

A first voltage V1 may be biased between the first transparent conducting layer 30 and the antenna pattern 70. A second voltage V2 may be biased between the metal reflective plate 10 and the first transparent conducting layer 30. When the first voltage V1 and the second voltage V2 are biased, a first charge concentration change layer 22 and a second charge concentration change layer 52 may be induced between the lower insulating layer 20 and the first transparent conducting layer 30 and between the second transparent conducting layer 50 and the upper insulating layer 60, respectively, thus changing a refractive index. As a result, the typical meta device 100 may modulate light.

The first charge concentration change layer 22 and the second charge concentration change layer 52 may individually control a refractive index through the first voltage V1 and the second voltage V2. Therefore, the typical meta device 100 may perform complex modulation using individual refractive index changes in the first charge concentration change layer 22 and the second charge concentration change layer 52.

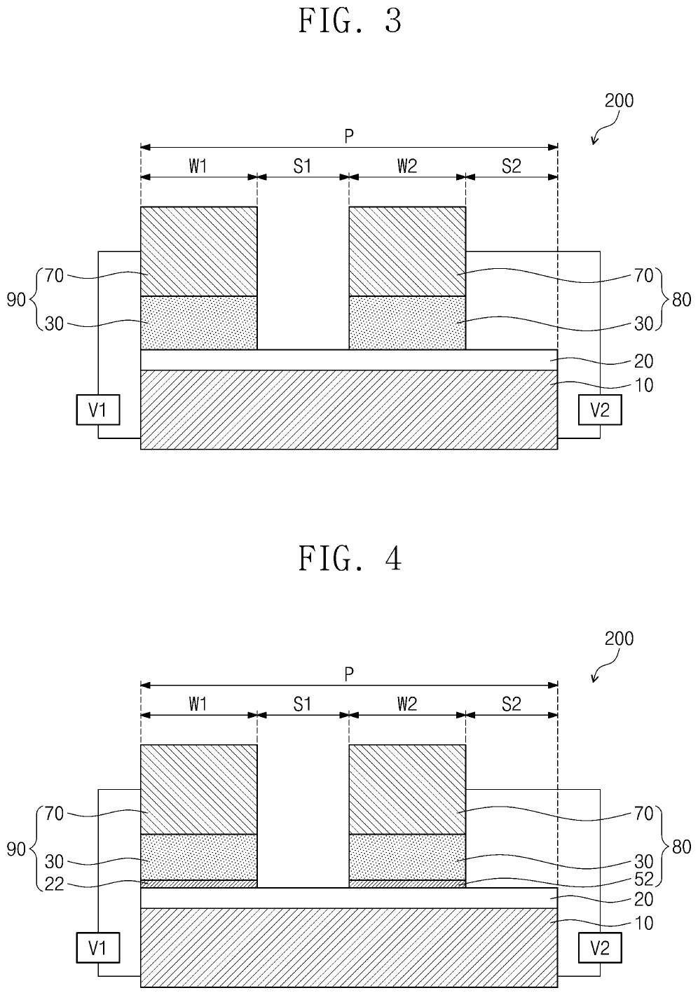

FIGS. 3 and 4 illustrate an example of an active meta device 200 according to the inventive concept.

Referring to FIG. 3, the active meta device 200 of the inventive concept may include a metal reflective plate 10, a lower insulating layer 20, a first modulation line block 80, and a second modulation line block 90. The metal reflective plate 10 may include silver (Ag).

The lower insulating layer 20 may be provided on the metal reflective plate 10. The lower insulating layer 20 may include alumina (Al₂O₃). Alternatively, the lower insulating layer 20 may include silicon oxide (SiO₂), silicon nitride (SiN), or polymer, but an embodiment of the inventive concept is not limited thereto. The lower insulating layer 20 may have a thickness of about 10 nm.

The first modulation line block 80 may be provided on one side of the lower insulating layer 20. The first modulation line block 80 may include a first transparent conducting layer 30 and a nano-antenna pattern 70. The first transparent conducting layer 30 may be provided on the lower insulating layer 20. The first transparent conducting layer 30 may include ITO, but an embodiment of the inventive concept is not limited thereto. The nano-antenna pattern 70 may be provided on the first transparent conducting layer 30. The nano-antenna pattern 70 may include molybdenum (Mo). Alternatively, the nano-antenna pattern 70 may include silver (Ag), but an embodiment of the inventive concept is not limited thereto.

The first modulation line block 80 may have a first line width W1. The first line width W1 may be about 44.4 nm to about 350 nm. The first modulation line block 80 may be spaced a first separation distance S1 apart from the second modulation line block 90. The first separation distance S1 may be about 50 nm to about 350 nm.

The second modulation line block 90 may be provided on another side of the lower insulating layer 20. The second modulation line block 90 may have a laminate structure similar to that of the first modulation line block 80. According to an example, the second modulation line block 90 may include the first transparent conducting layer 30 and the nano-antenna pattern 70.

The second modulation line block 90 may have a second line width W2. The second line width W2 may be the same as the first line width W1. The second line width W2 may be about 44.4 nm to about 350 nm. The second modulation line block 90 may be spaced a second separation distance S2 apart from the second modulation line block 90. The second separation distance S2 may be the same as the first separation distance S1. The second separation distance S2 may be about 50 nm to about 350 nm.

The first modulation line block 80 and the second modulation line block 90 may have a pitch P and may be periodically arranged on the lower insulating layer 20. The pitch P may be longer than a wavelength of visible light. The visible light may have a wavelength of about 400 nm to about 700 nm. The pitch P of the first modulation line block 80 and the second modulation line block 90 may be at least about 700 nm.

Different voltages may be biased to the first modulation line block 80 and the second modulation line block 90. A first voltage V1 may be biased between the metal reflective plate 10 and the nano-antenna pattern 70 of the first modulation line block 80, and a second voltage V2 may be biased between the metal reflective plate 10 and the nano-antenna pattern 70 of the second modulation line block 90.

Referring to FIG. 4, when the first voltage V1 and the second voltage V2 are biased, a first charge concentration change layer 22 and a second charge concentration change layer 52 may be induced in the first modulation line block 80 and the second modulation line block 90, respectively. The first charge concentration change layer 22 may be generated between the lower insulating layer 20 and the first transparent conducting layer 30 of the first modulation line block 80. The second charge concentration change layer 52 may be generated between the lower insulating layer 20 and the first transparent conducting layer 30 of the second modulation line block 90. The first voltage V1 and the second voltage V2 may control refractive indices of the first charge concentration change layer 22 and the second charge concentration change layer 52. That is, refractive indices of the first modulation line block 80 and the second modulation line block 90 may be individually controlled through the first voltage V1 and the second voltage V2. Therefore, the active meta device 200 of the inventive concept may make it possible to simplify a structure of a device while implementing complex modulation using the first modulation line block 80 and the second modulation line block 90 that are changed in refractive index according to the first voltage V1 and the second voltage V2.

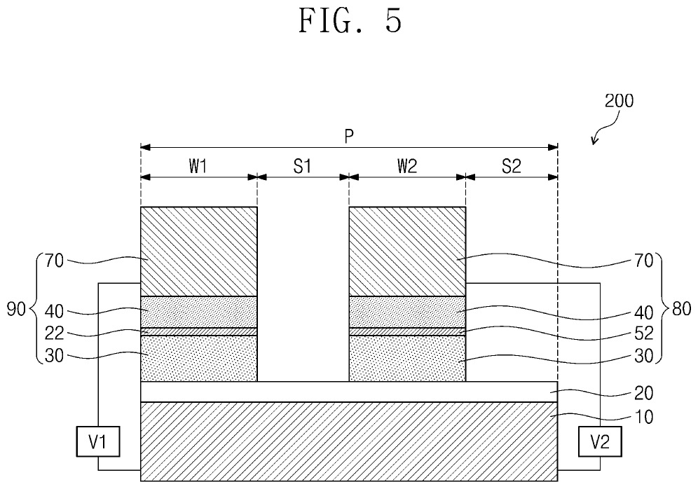

FIG. 5 illustrates an example of an active meta device 200 according to the inventive concept.

Referring to FIG. 5, the first modulation line block 80 and the second modulation line block 90 each may further include an opaque metal layer 40 between the first transparent conducting layer 30 and the nano-antenna pattern 70. The opaque metal layer 40 may include silver (Ag). The opaque metal may 40 may have a thickness of about 80 nm. When the first voltage V1 and the second voltage V2 are biased, the first charge concentration change layer 22 may be induced between the first transparent conducting layer 30 and the opaque metal layer 40 of the first modulation line block 80, and the second charge concentration change layer 52 may be induced between the first transparent conducting layer 30 and the opaque metal layer 40 of the second modulation line block 90.

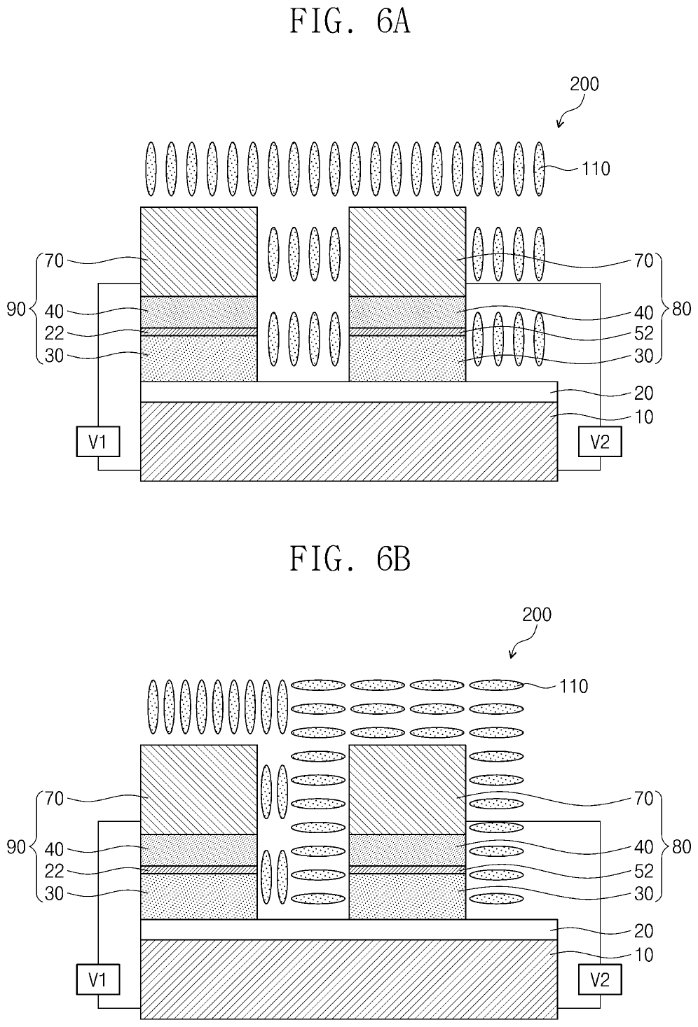

FIGS. 6A and 6B illustrate an example of the active meta device 200 according to the inventive concept.

Referring to FIG. 6A, a liquid crystal layer 110 may be provided on the first modulation line block 80 and the second modulation line block 90. The liquid crystal layer 110 may be provided on the lower insulating layer 20 between the first modulation line block 80 and the second modulation line block 90. In general, since an interaction with a nano-structure surface is strong in the liquid crystal layer 110, modulation may not easily occur due to an applied voltage on the nano-structure surface.

Referring to FIG. 6B, when the second voltage V2 higher than the first voltage V1 is biased, the liquid crystal layer 110 may be selectively modulated or oriented around the second modulation line block 90. Surfaces of the first modulation line block 80 and the second modulation line block 90 may be modified, thus minimizing surface energy between the blocks and the liquid crystal layer 110. The liquid crystal layer 110 on the first modulation line block 80 and the second modulation line block 90 may be oriented in a different direction according to the first voltage V1 and the second voltage V2 so as to modulate light.

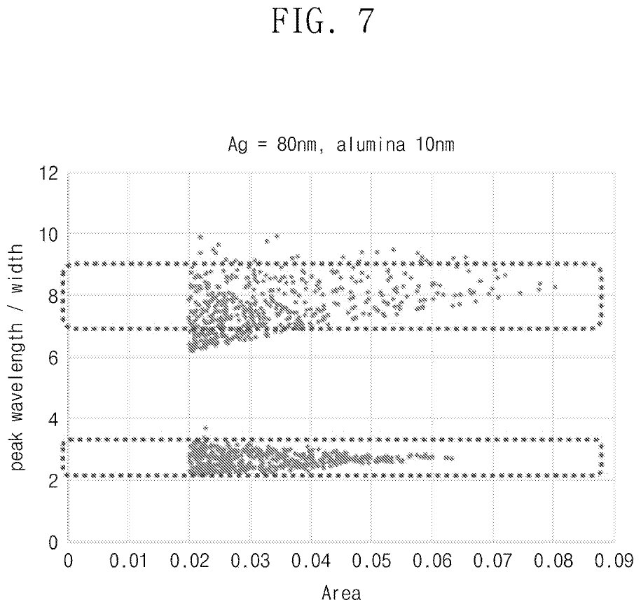

FIG. 7 is a simulation result pertaining to line widths of the first modulation line block 80 and the second modulation line block 90 relative to a peak wavelength of visible light according to a complex modulation area of the active meta device 200 of the inventive concept.

Referring to FIG. 7, a ratio WW of a wavelength A of visible light to line widths W of the first modulation line block 80 and the second modulation line block 90 may be larger than 7 and less than 9 and larger than 2 and less than 3. When the wavelength λ of visible light is about 400 nm to 700 nm, the line widths W of the first modulation line block 80 and the second modulation line block 90 may be about 44.4 nm to about 350 nm.

As described above, the meta device according to the inventive concept may make it possible to simplify the structure of the device while enabling complex modulation in a visible light region by using first and second block patterns that receive different first and second voltages and have a certain line width, separation distance, and pitch.

Although the embodiments of the present invention have been described, it is understood that the present invention should not be limited to these embodiments but various changes and modifications can be made by one ordinary skilled in the art within the spirit and scope of the present invention as hereinafter claimed.

What is claimed is:

1. An active meta device comprising:
a metal reflective plate;
an insulating layer on the metal reflective plate;
a first modulation line block provided on one side of the insulating layer; and
a second modulation line block provided on another side of the insulating layer facing the first modulation line block.

2. The active meta device of claim 1, wherein the first modulation line block and the second modulation line block each include:
a transparent conducting layer; and
a nano-antenna pattern on the transparent conducting layer.

3. The active meta device of claim 2, wherein a first voltage is biased between the metal reflective plate and the nano-antenna pattern of the first modulation line block, and a second voltage is biased between the metal reflective plate and the nano-antenna pattern of the second modulation line block.

4. The active meta device of claim 2, wherein the transparent conducting layer includes indium tin oxide (ITO).

5. The active meta device of claim 2, wherein the first modulation line block and the second modulation line block each further include an opaque metal layer between the transparent conducting layer and the nano-antenna pattern.

6. The active meta device of claim 5, wherein the opaque metal layer includes silver.

7. The active meta device of claim 1, wherein the first modulation line block and the second modulation line block are alternately arranged with a pitch of at least 700 nm.

8. The active meta device of claim 1, wherein the first modulation line block and the second modulation line block each have a line width of 44.4 nm to 350 nm.

9. The active meta device of claim 1, wherein the first modulation line block and the second modulation line block have a separation distance of 50 nm to 350 nm.

10. The active meta device of claim 1, wherein the insulating layer includes alumina.
